(19) United States
(12) Patent Application Publication
(10) Pub. No.: US 2002/0119219 A1
(43) Pub. Date: Aug. 29, 2002

(54) Coated food products made from shaped dough substrates and method of preparing same

(76) Inventors: Brian K. Doyle, Alto, MI (US); Cheree L. Stevens, Idaho Falls, ID (US); John F. Stevens, Idaho Falls, ID (US); Sheila S. Carter, Shelley, ID (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/025,403

(22) Filed: Dec. 19, 2001

Related U.S. Application Data
(60) Provisional application No. 60/258,026, filed on Dec. 22, 2000.

(51) Int. Cl. A23G 3/00

(52) U.S. Cl. 426/94

(57) ABSTRACT

A new type of food product made from shapeable, shape-retaining dough whose principal ingredient may be potato or essentially any grain-based flour or the like. The dough is shaped, coated with a batter/slurry made from flour or starch and water plus desired seasoning, coloring, etc., and then cooked, or parfried and frozen for subsequent reconstitution (finish-cooking) in a toaster, gradient oven, microwave oven, grill, broiler or the like. The finished product has a crispy/crunchy exterior and a light, fluffy interior, with many variations made possible by different dough types, etc. One particular embodiment is a potato waffle which is reconstitutable in a domestic toaster and has a soft, moist interior and crispy exterior.

### CROSS-REFERENCE To RELATED APPLICATION

The present invention claims priority to Provisional Patent Application Serial No. 60/258,026, filed on Dec. 22, 2000 entitled COATED FOOD PRODUCTS MADE FROM SHAPED DOUGH SUBSTRATES.

### FIELD OF THE INVENTION

This invention relates generally to food products made from dough compositions, i.e., moldable shape-retaining food masses which comprise intermixed combinations of one or more base ingredients such as flour made from grain or the like, shredded or otherwise processed potato or other such natural food substances, together with water and other selected ingredients to form a shapeable mass that can be formed into various desired shapes prior to further processing, as for example by baking or frying (including deep frying). More particularly, the invention relates to shaped dough food products of the foregoing nature which are coated with a batter or slurry prior to further processing, such as by parfrying and freezing for storage, and then reconstituted or subjected to final cooking, or final cooking without the intermediate parfrying and freezing steps.

Viewed from a different perspective, the invention broadly relates to a new type of food product, characterized for purposes of example by a waffle-like or other such shaped patty made (for example) from dough whose principal ingredient comprises dehydrated potato which, after shaping, is coated with a flour or starch-based mixture applied as a batter or slurry, and then further processed, as by parfrying, freezing, and reconstituting by final cooking/heating in an oven, toaster, deep fryer, grill, broiler or microwave.

### BACKGROUND OF THE INVENTION

Although the invention is considerably broader in overall scope, it is useful for illustrative purposes to consider it as utilized to make shaped and formed food products such as a waffle or various other and more intricate shapes, for example stars, crescents, etc., having elongated, narrow sections, which are made from a dough mass whose basic or primary ingredient may be potato, preferably (but not necessarily) dehydrated potato, plus other desired ingredients.

Broadly speaking, shaped food products made from a wide variety of grain-based dough substances are of course very well known (particularly those made from wheat or other such grain-based flour); however, the difficulty of making satisfactory such products increases markedly with the intricacy of the shape desired since such products are well known to be fragile, and they readily break or crumble after baking. Insofar as potato-based products are concerned, items such as french fries, “lattice-cuts,” hash browns, etc. made from sliced or shredded raw potatoes are of course well known, but food products made from potato dough are largely unknown. In fact, the only such product believed to be known and commercially available heretofore is a potato “waffle” which is made from fresh potatoes that have been cooked and mashed, mixed with a substantial amount of stabilizers and binders, etc. to hold the wet potato mass together, and then shaped into a perforated disc which is deep-fried and frozen, for subsequent reconstitution by frying or broiling. Inherently, the mashed potato medium from which such products are made is extremely wet and heavy, and it is not very cohesive. As a result, no intricate shapes are possible and the resulting deep-fried product has a rather heavy interior consistency and contains a high amount of fat (which is exchanged for the water in the potato mass during the deep-frying process). Furthermore, the frozen product must be reconstituted by broiling, or in a gradient oven (or fried, or deep fried), and it does not have a soft, fluffy interior, nor a light and crispy exterior.

Apart from the potato waffles known previously, as noted above, it is known that potato-based masses using shredded potato or mashed potato substrates from mashed or dehydrated potato can be formed into relatively blocky or thick products, such as cylinders or cubes, patties, croquettes, etc., which are usually deep-fried and refrigerated or frozen deep-fried and/or frozen in a somewhat compressed state for packaging and retailing. These products do not hold together well when defrosted and they become crumbly when reconstituted for consumption (in a gradient oven or the like). Such manufacturing media and procedures do not permit the preparation of satisfactory products with intricate shapes, and the thick, chunky products which they do permit do not turn out to be crispy on the outside or smooth and fluffy on the inside. Thus, they cannot successfully be made, sold, and used in a waffle-like shape or other such patty/pancake configuration, much less anything more intricate in shape. Most certainly, they cannot be reconstituted for consumption in a domestic toaster.

### BRIEF SUMMARY OF INVENTION

Broadly considered, the present invention provides a new form or type of processed food product. In its most basic form, this new form or type of food product comprises a shaped or formed dough item, which may have practically any desired base constituent such as flour made from wheat or other grains, potatoes, etc., with an outer coating or enrobing that is preferably and/or principally applied as a starch-based or flour-based slurry or batter. In the most preferred embodiment, this coated, shaped dough food product is pre-cooked, such as by parfrying, and then frozen for storage prior to subsequent reconstitution, which may be done by practically any known means, including a domestic toaster. The result is a new type of food product which has a very appealing crunchy or crispy exterior and a light, fluffy interior, such as has not previously been available or known in the art.

In a particular preferred embodiment, the new form or type of food product provided herewith may comprise a potato waffle, made from a dough principally comprising either dehydrated or fresh potato that has been shaped into the form of a waffle, batter-coated, parfried and then frozen.

In summary form, additional aspects of the invention include the optional application of a dry, particulate media such as cornstarch or the like to the shaped dough substrate prior to the application of the wet batter/slurry (“predustng”), by which greater exterior crispness and also increased surface smoothness is obtained. While reconstitutable in a domestic toaster, practically any other process may also be used, such as a gradient oven, microwave or even a deep fat fryer, by which the exterior of the product is made even more crunchy and crispy. Essentially the same light, fluffy interior is obtained regardless of the type of reconstitution used, and the batter/slurry outer coating may include desired seasonings, colorings, etc.

### DESCRIPTION OF PREFERRED EMBODIMENTS

A particular illustrative preferred embodiment of the present invention, as referred to above, comprises a potato-based waffle which may be stored and shipped in a frozen condition, is reconstitutable in a domestic toaster, and which, when so reconstituted has a crispy exterior and a smooth, fluffy, light interior. The outer appearance of the waffle may basically resemble a conventional waffle, having a somewhat checkerboard-like appearance that includes a series of indentations that pass either partially or completely through the thickness of the waffle and facilitate more uniform baking or cooking. In the present case, however, the particular shape is not at all critical, since the new form of food product provided herewith may be given essentially any desired shape, including more intricate and imaginative configurations that incorporate thin, elongated portions (such as stars, spiral-like swirls, etc.), inasmuch as the novel composition and preparation impart substantially increased surface strength which allows such thin, elongated shapes to avoid breakage in shipment and usage, even after reconstitution and while the product is hot and ready for consumption, while at the same time maintaining the desired light and fluffy internal consistency.

In the particular preferred embodiment under discussion, a potato “dough” is prepared, using either dehydrated or fresh cooked potato, egg, milk, a small amount of stabilizer or binder and desired seasonings, for example in the following portions:

| Ingredients | Percentage |
|---|---|
| Water | 70.00 |
| Dried whole egg | 0.90 |
| Dehydrated potato granules | 27.30 |
| Skim milk | 0.60 |
| Methocel | 0.30 |
| Salt | 0.90 |
| | 100.00 |

These ingredients are intermixed to form a pliable or plastic dough mass having an approximate water content of 65-75% (with 70% considered optimal), which may be formed into any of the desired shapes. The resulting dough shapes are then either directly coated with the selected batter coating or, if increased surface crispness or crunchiness is desired, the shapes may first be dusted (“predusted”) with a desired starch or flour composition, for example, corn starch or the like. Alternatively, a dry preparation of a selected known batter/slurry coating composition, such as may be combined with water to produce a wet batter or slurry coating substance, may be used for the predusting. As noted above, predusting not only enhances the outer surface crispness of the reconstituted product but also provides a very smooth final surface for the food product.

The batter/slurry coating may consist of, but is not limited to, essentially any desired combination of water plus potato, wheat, corn, or other starches (which may be starch per se or flour), plus spices, coloring, leavening, salt, etc. Examples of particular coatings used on sliced potatoes which yield desirable results in this invention are set forth in commonly-owned co-pending Application Nos. 60/180,666 and 60/234,153 (unofficial), which are incorporated herein by reference as fully as though set forth verbatim herein. After being so coated, the product is parfried and frozen for storage and shipment.

As already noted, various forms of reconstitution may be used, including toasting (even by use of domestic toasters), oven baking, grilling, broiling, microwaving, deep-frying, etc. Deep-frying will, as noted above, produce even greater degrees of outer crispness.

While the relative thickness of the underlying dough substrate and the outer batter coating is not a matter of principal concern, it is believed that, at least in the case of potato dough substrates as noted above, product thickness should not exceed about 4 cm. The outer coating will generally be relatively thin, for example about 1 mm thick, and it may be desirable to utilize thicker coatings obtained by multiple applications of the batter/slurry or by using more viscous batter slurries.

The present limited state of the art, briefly set forth above, severely limits the available shapes which can as a practical matter be utilized in making shaped dough-based products, particularly those with intricate shapes or relatively thin sections, other than hard and essentially rigid things like pretzels, which are made by a much different process. That is, pretzels are made from wheat flour, active yeast, sugar, and water. The ingredients are made into dough and then formed into the desired shape. The formed dough is then placed into boiling water that has an alkaline pH by the addition of sodium bicarbonate. The boiled pretzel shapes are then baked at relatively high temperatures (475° F.). The heat treatment using an alkaline water cook is necessary to produce the surface dough strength required to give the resultant characteristic “crack” to the finished product on baking. Of course, pretzels are an entirely different type of food product, conventional thin pretzels being hard and rigid, crunchy throughout, and not at all soft on the interior. No comparable such products are known which are made from potato or the like, or which have a light and fluffy interior, “soft” pretzels being essentially a heavy, bread-type product which has integral, self-reinforcing loops rather than long extending thin portions.

As is well known, other presently-known types of dough-based food products with long, thin sections (such as star-shaped or crescent-shaped cookies, etc.) are fragile and break apart during shipping, etc., as they have very limited strength due to their relatively low solids content and inherently weak structure. By adding an exterior batter/slurry coating to such food items prior to cooking (whether by precooking, e.g., parfrying and later finish-cooking, or by using a one-step cooking process), in accordance with the present invention, the resulting product has substantially increased surface strength, which makes such products far more desirable and feasible and allows for satisfactory preparation of numerous other such types of products. Furthermore, the resultant product is pleasingly crispy on the surface but light and fluffy on the inside. The outer coating not only provides strength and texture, but also provides a medium for adding securely adhered surface particulates and/or dissolved ingredients, such as seasonings, flavors, colors, etc. In effect, the batter/slurry outer coating provides a continuous, thin, smooth outer shell, resulting in very little crumb formation. By varying the content of the batter and/or predusting which is utilized, a variety of different surface configurations may be obtained, as well as a variety of different outer appearances and flavors, including rough outer surfaces as well as smooth ones, and the resulting attractive, flavorful product has substantially enhanced outer surface integrity and overall strength, to resist breakage and crumbling under most or all expected conditions.

An important point to be emphasized here is that products made in accordance with the invention are reconstitutable in an ordinary domestic toaster, even where they are made in the form of a potato waffle, and when so reconstituted have a light, fluffy interior which is not unlike freshly prepared mashed potato. At the same time, the reconstituted products have an appealing crunchy exterior, such that the overall texture approaches that of a coated and deep-fried product, while also being strong and shape-retaining in character, enabling embodiment in many novel shapes such as stars, spirals, swirls, crescents, etc. Of course, the resulting product (after initial forming, coating, and cooking) can also be reconstituted with complete success in an ordinary oven by baking, or broiling, or one can grill the product, shallow-fry it, deep-fry it, etc.

The particular interior consistency of the product results from the particular dough formulation and content used, and in the case of potato dough products such as the toaster waffle noted above, it is desirable to eliminate the excess moisture which inherently comes from the use of raw potatoes, as for example, by using at least partially dehydrated potato, in particulate or flake form, etc. While fresh or even raw potatoes may be utilized, it is desirable to cook them first and, preferably, dry or partially dry the resulting wet potato mass either before or after mixing it with the other ingredients to be used in the dough. As for the dough constituents, it is believed very desirable (particularly where a potato waffle is to be produced) to utilize eggs as one ingredient, since that not only adds desirable flavor and mouth appeal, but increases cohesiveness of the potato dough while also helping to produce a fluffy and light consistency. As also noted above, at least some stabilizers are desired in such a dough, for example, carageenan, gum arabic, carboxymethylcellulose, and/or guar gum, but these may be utilized in relatively small amounts compared to the prior art uncoated potato waffle referred to above, which takes on an increased fat content during the deep-frying step as a result of the excess moisture present in the potato mass utilized.

Further contrasted with such prior art products, it is to be noted that the new form of food products made in accordance with the present invention may take many desired relatively intricate forms including thin disc-like patties or pancakes, which are inherently shape-retaining due to their crunchy or crisp exterior coating, while nonetheless having light and fluffy interiors and relatively low overall fat. The light, fluffy interior which is obtainable in accordance with the invention is analogous to but lighter and fluffier than conventional prepared mashed potatoes, and it also avoids the inclusion of an excessive amount of starches, stabilizers, gums, etc. in the dough. Furthermore, the preferred potato dough is readily moldable or otherwise formable (i.e., plastically deformable), and highly shape-retaining, particularly due to the inclusion of eggs, as noted above, as well as a small amount of stabilizer.

Of course, other but analogous considerations are involved where the shaped dough product is made from wheat or other grain flour (including corn and rice), but the basic underlying considerations are much the same or highly similar. In this regard, essentially any plastically deformable or other such shape-retaining food dough may be utilized, and the shaped dough may be given practically any form, even emulating conventional products made from raw vegetables or the like, e.g., potato, such as potato slices for chips, “ranch fries,” etc., while nonetheless possessing the desired crunchy exterior and light, fluffy interior. In this regard, it is to be noted that the batter/slurry (or dry-form) coating may be based on essentially any combination of flours or starches, including wheat, corn, potatoes, rice, etc. (referred to generally herein as “particulate starch component,” whether in slurry or dry form), selected to promote a particularly desired exterior coating characteristic.

The resulting product is different and better than those produced by the use of natural, raw potatoes or the like, including mashed potatoes, which (as indicated above) cannot be formed into a shape-retaining item without the addition of a large amount of gums, stabilizers, etc., and even then are not desirable due to their high inherent water content. At least where potatoes are concerned, it is presently believed that they must be cooked or subjected to a drying process before inclusion into the dough which is to be shaped, coated, etc. The dough desirably is of a “stiff” character, pliable, moldable, and shape-retaining (e.g., plastically deformable). Where wheat or other such grains are the principal ingredient in the dough, however, the desired stiff dough mass may be produced without pre-cooking or using high levels of stabilizers, etc.

It is believed that those skilled in the art will immediately recognize the novel and unobvious character of the type of food product disclosed above, and also immediately recognize the wide scope of applicability and high degree of commercial promise which it possesses. Of course, the above description is considered that of the preferred embodiments only. Modifications and variations of this and other such embodiments may well occur to those skilled in the art and to those who make or use the invention after learning of it through access to such preferred embodiments. Accordingly, it is to be understood that the embodiment shown in the drawings and described above is merely for illustrative purposes and should not be used to limit the scope of the invention, which is defined by the following claims as interpreted according to the principles of patent law, including the doctrine of equivalents.

The invention claimed is:

1- A new type of cooked food product comprising a shaped substrate made from moldable, edible dough, and an exterior coating on said shaped substrate made from a particulate starch component base, said coating being applied to said substrate prior to cooking said substrate and cooked in place thereupon.

2- A new type of cooked food product as set forth in claim 1, wherein said coating comprises a batter or slurry at the time it is applied and a dry layer on said substrate after cooking.

3- A new type of cooked food product as set forth in claim 1, wherein said coating comprises a dry mix of ingredients when applied.

4- A new type of food product as set forth in claim 1, wherein the principal non-liquid ingredient of said dough comprises potato.

5- A new type of food product as set forth in claim 4, wherein said substrate is in the form of a waffle.

6- A new type of food product as set forth in claim 1, wherein the principal non-liquid ingredient of said dough comprises a flour made from grain.

7- A new type of food product as set forth in claim 1, wherein said substrate has a shape having at least one slender and elongated portion, said exterior coating forming a shell surrounding said slender and elongated portion which strengthens it to resist breakage.

8- A new type of food product as set forth in claim 1, wherein said food product comprises a deep-fried product.

9- A new type of food product as set forth in claim 8, wherein the principal non-liquid ingredient of said dough comprises potato.

10- A new type of food product as set forth in claim 1, wherein said food product comprises a non-fried product.

11- A new type of food product as set forth in claim 4, wherein said dough includes at least some partially cooked potato prior to being cooked with said substrate in place.

12- A new type of food product as set forth in claim 4, wherein said dough includes at least some dehydrated potato.

13- A new type of food product as set forth in claim 1, wherein said coating comprises a dry particulate starch component disposed inside a slurry-form component prior to cooking.

14- A new type of food product as set forth in claim 1, wherein said substrate and coating comprise a parfried article.

15- A new type of food product as set forth in claim 14, wherein said substrate and coating further comprise a non-fried finished-cooked component.

16- A new type of food product as set forth in claim as set forth in claim 14, wherein said substrate and coating further comprise a finish-cooked fried component.

17- A new type of food product as set forth in claim 1, wherein said food product comprises a parfried and frozen product.

18- A new type of food product as set forth in claim 1, wherein said food product has a crispy exterior and a soft interior.

19- A new type of food product as set forth in claim 18, wherein said food product comprises a waffle.

20- A new type of food product as set forth in claim 18, wherein said food product comprises a baked product.

21- A new type of food product as set forth in claim 18, wherein said food product comprises a cookie.

22- A new type of food product as set forth in claim 20, wherein said food product has a shape having at least one slender and elongated portion, said exterior coating forming a shell surrounding said slender and elongated portion which strengthens it to resist breakage.

23- A new type of food product as set forth in claim 1, wherein said substrate and coating have an overall thickness of not more than about 4 cm.

24- A method of making a food item, comprising the steps of:
shaping a formable shape-retaining food dough item having a desired configuration;
coating said shaped dough food item with a particulate starch-component ingredient mix; and
cooking said shaped and coated dough food item with said coating in place upon it, to thereby obtain a shaped food product having a crispy exterior and a soft interior.

25- The method of claim 24, wherein said step of cooking said coated and shaped dough food item includes parfrying it and later finish-cooking it.

26- The method of claim 25, further including the step of freezing said parfried food item prior to finish-cooking it.

27- The method of claim 25, wherein said step of finish-cooking comprises reconstituting the frozen parfried food item by thawing it and then cooking it by using at least a selected one of the group consisting essentially of a gradient oven, a microwave oven, a toaster, a grill, a broiler, and a deep-fryer.

28- The method of claim 27, wherein said toaster comprises a domestic toaster.

29- The method of claim 27, wherein said step of shaping a food dough comprises forming a patty from potato dough.

30- The method of claim 29, wherein said forming step comprises making a waffle shape from said potato dough.

31- The method of claim 30, wherein said step of finish-cooking includes using a toaster.

32- The method of claim 27, wherein said step of shaping comprises forming said dough into a pancake.

33- The method of claim 27, wherein said step of shaping comprises forming said dough into a shape which emulates a slice of a natural food.

34- The method of claim 24, including the step of using a food dough whose main ingredient is at least a selected one of the group consisting essentially of flour or starch made from grain.

35- The method of claim 25, including the step of using a food dough whose main ingredient comprises a shredded non-grain natural food.

36- The method according to claim 35, wherein said shredded non-grain natural food is at least partially dried before using it in said dough.

37- The method according to claim 35, wherein said shredded natural food is at least partially dehydrated before inclusion in said dough.

38- The method according to claim 25, wherein said step of coating said shaped dough food item comprises predusting it with a dry particulate starch-component ingredient mix and subsequently applying a particulate starch-component mix which is in batter/slurry form.

39- The method according to claim 29, including the step of using egg in the potato dough to increase cohesiveness of such dough and help produce a fluffy and light internal consistency after cooking.

40- The method according to claim 39, including the step of using at least some stabilizers in said dough.
